(19) United States
(12) Patent Application Publication
(10) Pub. No.: US 2005/0067283 A1
(43) Pub. Date: Mar. 31, 2005

(54) Sensor element

(76) Inventor: Lothar Diehl, Gerlingen (DE)

Correspondence Address: KENYON & KENYON, ONE BROADWAY, NEW YORK, NY, 10004, US

(21) Appl. No.: 10/917,895

(22) Filed: Aug. 13, 2004

(30) Foreign Application Priority Data
Aug. 14, 2003 (DE) 103 37 573.2

(51) Int. Cl. G01N 27/26

(52) U.S. Cl. 204/426

(57) ABSTRACT

A planar, layered sensor element for detecting a physical property of a gas to be analyzed is provided. The sensor element has at least one inner, first solid-electrolyte layer which is situated between two outer solid-electrolyte layers, a second solid-electrolyte layer being one of the outer solid-electrolyte layers. The inner, first solid-electrolyte layer and the second solid-electrolyte layer contain zirconium oxide stabilized with yttrium oxide. The inner, first solid-electrolyte layer has a higher yttrium-oxide content than the second solid-electrolyte layer, the yttrium-oxide content being based on the zirconium oxide.

### FIELD OF THE INVENTION

The present invention relates to a planar, layered gas sensor element.

### BACKGROUND INFORMATION

Planar, layered sensor elements are discussed, for example, in Automotive Electronics Handbook, 2^{nd} Ed., Ronald K. Jurgen, McGraw-Hill, 1999. A distinction is made amongst, inter alia, voltage-jump lambda sensors, wide-range lambda sensors, and limiting-current sensors. The sensor elements have a plurality of solid electrolyte foils or films, to which (and between which) different layers, e.g., electrodes or porous layers, are applied. In addition, voids are introduced into (or between) the solid-electrolyte foils.

The solid-electrolyte foils are made up of zirconium oxide (ZrO₂) stabilized with yttrium oxide (Y₂O₃), along with small additions of aluminum oxide (Al₂O₃) and/or silicon oxide (SiO₂). The level of yttrium oxide is usually 4 to 5 mole percent.

In this context, it is disadvantageous that such solid-electrolyte foils have a low tensile strength, and that cracks can occur in such solid-electrolyte foils, due to mechanical loading or stress caused by temperature differences.

Published German patent document DE 198 57 470 discloses that a foil binder layer positioned between two solid-electrolyte foils can be provided with an yttrium-oxide content of 16 mole percent.

### SUMMARY OF THE INVENTION

The planar, layered sensor element according to the present invention is a sensor element having solid-electrolyte layers made of zirconium oxide stabilized with yttrium oxide, which sensor element has a high tensile strength and may resist high mechanical loads and stresses occurring due to temperature differences.

The sensor element according to the present invention includes a first solid-electrolyte layer positioned on the inside of the sensor element, which first solid-electrolyte layer has a higher yttrium-oxide level than a second solid-electrolyte layer positioned on the outside. As used in this specification, the level of yttrium oxide is the level of yttrium oxide in mole percent, based on the zirconium oxide, as long as nothing else is mentioned. Since the externally situated, solid-electrolyte layers are particularly subjected to high mechanical loadings and stresses, the susceptibility to cracking of the outer solid-electrolyte layer is advantageously reduced by selecting a low yttrium-oxide level for the outer solid-electrolyte layer. However, the first inner solid-electrolyte layer has a higher yttrium-oxide level, which means that the conductivity of the first solid-electrolyte layer with regard to oxygen ions is improved. This improves the measuring performance of an electrochemical cell, which is formed by two electrodes and the first solid-electrolyte layer region situated between the two electrodes.

The first and the second solid-electrolyte layers may have a level of zirconium oxide of at least 85 mole percent, e.g., 90 mole percent. The first solid-electrolyte layer may have an yttrium-oxide level which is at least 1 mole percent (e.g., 2 mole percent) greater than the yttrium-oxide level of the second solid-electrolyte layer.

An excellent strength of the sensor element, in addition to an improved measuring performance of the sensor element, may be achieved by providing a first solid-electrolyte layer that has 4 to 7 mole percent yttrium oxide, and providing a second solid-electrolyte layer has 3 to 4 mole percent yttrium oxide (in each instance, based on the zirconium oxide).

The second solid-electrolyte layer may be formed by a layer applied to the outer surface of the sensor element, using thick-film technology. This layer is used, for example, to cover an electrode and/or electrode lead situated on a surface of the sensor element. The second solid-electrolyte layer may cover the outside surface of the sensor element completely or substantially completely.

In an alternative exemplary embodiment of the present invention, the second solid-electrolyte layer is formed by a solid-electrolyte foil. A solid-electrolyte foil is a solid-electrolyte layer which is produced from a so-called green foil, using a sintering process. After sintering, such solid-electrolyte foils usually have a thickness of 200 to 500 μm, and, prior to sintering, i.e., as a blank foil, they are printed over with pastes, using thick-film technology. After the sintering, the pastes form functional layers, such as electrodes, protective layers, insulation layers, voids, or porous layers (when pore-forming materials are used).

The two outer surfaces of the sensor element parallel to the large surface of the sensor element may be formed by a solid electrolyte having a composition, which gives the solid electrolyte a high mechanical strength and, consequently a high tensile strength, for example.

In a third exemplary embodiment of the present invention, the sensor element has a further solid-electrolyte layer on at least one of its outer surfaces extending perpendicularly to the large surface of the sensor element, the composition of the further solid-electrolyte layer corresponding to the composition of the second solid-electrolyte layer.

Such sensor elements often have a measuring region heated by a heater. The second solid-electrolyte layer may be provided on the side of the sensor element adjacent to the heater since, on this side of the sensor element, high stresses may occur in the outer solid-electrolyte layer due to the temperature gradients produced by the heater.

### BRIEF DESCRIPTION OF THE DRAWINGS

FIG. 1 shows a cross-sectional view of a first exemplary embodiment of a sensor element according to the present invention, the view extending perpendicularly to the longitudinal axis of the sensor element.

FIG. 2 shows a cross-sectional view of a second exemplary embodiment of a sensor element according to the present invention, the view extending perpendicularly to the longitudinal axis of the sensor element.

FIG. 3 shows a longitudinal cross-sectional view of a third exemplary embodiment of a sensor element according to the present invention.

FIG. 4 shows a detailed portion of another exemplary embodiment of a sensor element according to the present invention.

FIG. 5a shows a schematic illustration of yet another exemplary embodiment of a sensor element according to the present invention.

FIG. 5b shows a schematic illustration of yet another exemplary embodiment of a sensor element according to the present invention.

### DETAILED DESCRIPTION

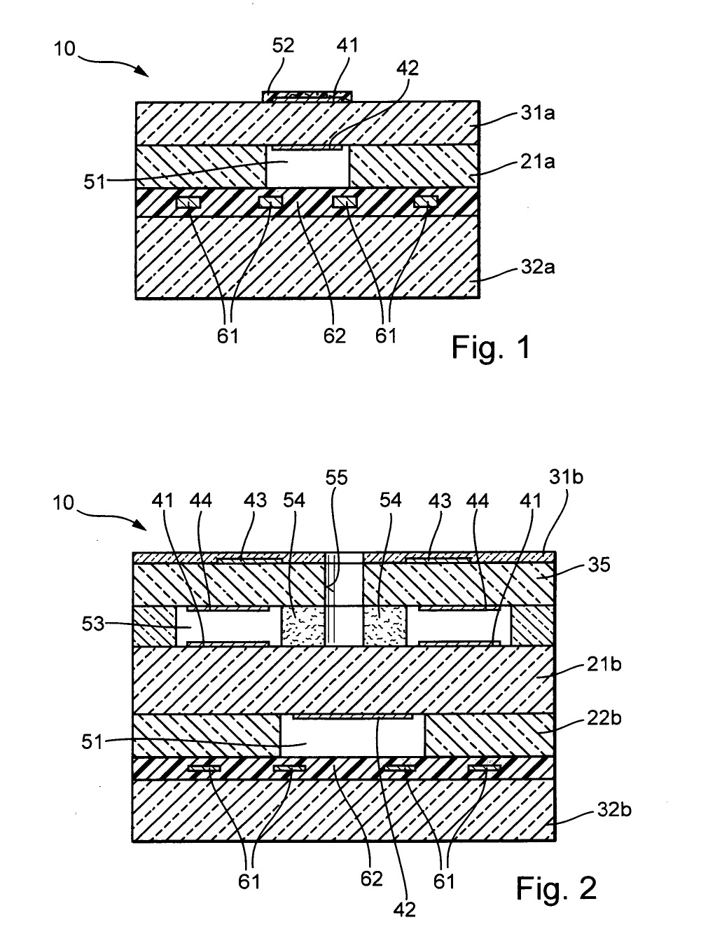

In FIG. 1, a cross-section of a first exemplary embodiment of a sensor element 10 according to the present invention is shown. The sensor element, which is referred to as a voltage-jump lambda sensor, includes three solid-electrolyte foils, namely an inner solid-electrolyte layer 21a, a first outer solid-electrolyte layer 31a, and a second outer solid-electrolyte layer 32a. A first electrode 41, which is covered by a porous protective layer 52, is applied to the outer surface of first outer solid-electrolyte layer 31a. A second electrode 42 is provided on first outer solid-electrolyte layer 31a, opposite to first electrode 41. Second electrode 42 is situated in a reference-gas chamber 51, which is formed inside the inner solid-electrolyte layer 21a. A voltage is generated between first and second electrodes 41 and 42, due to the different partial pressures of oxygen at first electrode 41 (gas to be analyzed) and at second electrode 42 (reference gas). A heater 61 is provided between the inner solid-electrolyte layer 21a and the second outer solid-electrolyte layer 32a, which heater 61 is separated from surrounding solid-electrolyte layers 21a and 32a by a heater insulation 62.

A cross-section of a second exemplary embodiment of the present invention is shown in FIG. 2. In this figure and in the following figures, identical elements are indicated by the same reference numerals throughout. Sensor element 10 according to FIG. 2 is referred to as a wide-range lambda sensor and includes four solid-electrolyte foils, namely a first inner solid-electrolyte layer 21b and a second inner solid-electrolyte layer 22b, a further solid-electrolyte layer 35, and a second outer solid-electrolyte layer 32b. Situated between the further solid-electrolyte layer 35 and the first inner solid-electrolyte layer 21b is an annular measuring-gas chamber 53; the measuring gas located outside of sensor element 10 may reach the chamber 53 by traveling through a gas-entrance orifice 55 extending through the further solid-electrolyte layer 35 and through a diffusion barrier 54. A reference-gas chamber 51 is introduced into the second inner solid-electrolyte layer 22b.

As shown in FIG. 2, on opposite lateral sides of the first inner solid-electrolyte layer 21b, first electrode 41 is deposited in the measuring-gas chamber 53 and second electrode 42 is deposited in the reference-gas chamber 51. A third electrode 43 is provided on the outside surface of the further solid-electrolyte layer 35. In the measuring-gas chamber 53, a fourth electrode 44 is situated on further solid-electrolyte layer 35, opposite to third electrode 43. The outside surface of the further solid-electrolyte layer 35 and third electrode 43, as well as a lead to third electrode 43 extending along the longitudinal axis of the sensor element on its exterior, are covered by a first outer solid-electrolyte layer 31b. The first outer solid-electrolyte layer 31b is porous, so that the gas to be analyzed may reach the third electrode 43. The first outer solid-electrolyte layer 31b has an opening in the region of gas-entrance orifice 55.

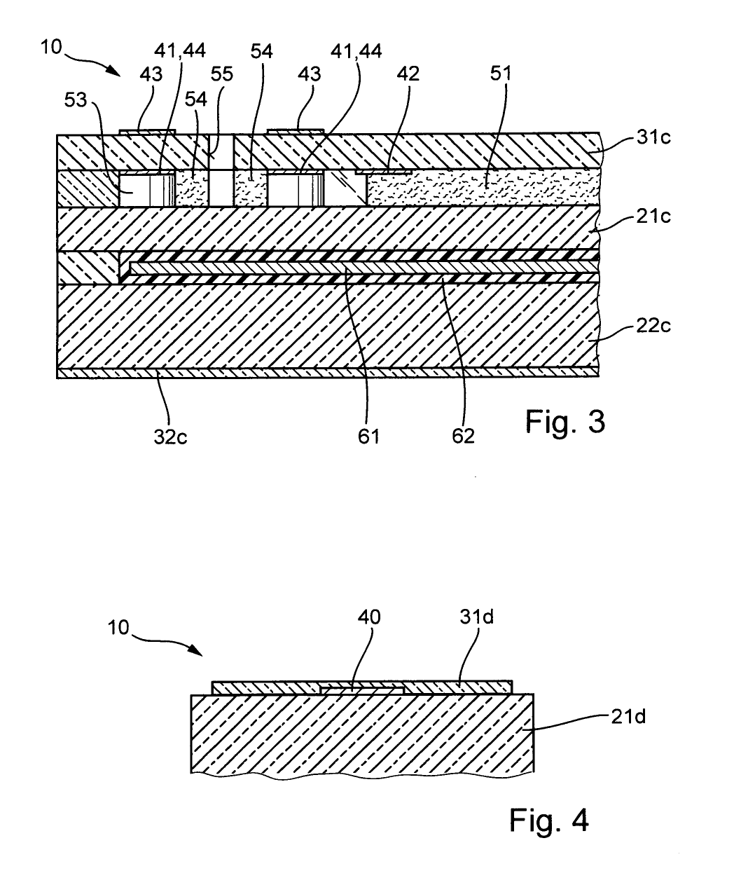

A longitudinal cross-section of a third exemplary embodiment of the present invention is shown in FIG. 3. Sensor element 10 according to FIG. 3 is a wide-range lambda sensor that differs from the exemplary embodiment according to FIG. 2 in that the sensor element 10 of FIG. 3 includes three solid-electrolyte foils, namely a first outer solid-electrolyte layer 31c, a first inner solid-electrolyte layer 21c, and a second inner solid-electrolyte layer 22c. Measuring-gas chamber 53 and reference-gas chamber 51 are provided in the layer plane between first outer solid-electrolyte layer 31c and first inner solid-electrolyte layer 21c; the reference-gas chamber 51 is filled with a porous material. In the alternative, the reference-gas chamber may beformed by the porous, second electrode and/or the porous lead to the second electrode. Third electrode 43 is situated on the outside of the first outer solid-electrolyte layer 31c, and the second electrode 42 is situated in the reference-gas chamber 51, on the first outer solid-electrolyte layer 31c. Electrodes 41 and 44 situated in the measuring-gas chamber 53, on the first outer solid-electrolyte layer 31c, combine the functions of the first and fourth electrodes of the second exemplary embodiment shown in FIG. 2. Heater 61 and heater insulation 62 are situated between first inner and second inner solid-electrolyte layers 21c, 22c. The outside of the second inner solid-electrolyte layer 22c is covered by a second outer solid-electrolyte layer 32c, which is applied to the second inner solid-electrolyte layer 22c prior to sintering, using screen printing.

As shown in a detailed portion in FIG. 4, a fourth exemplary embodiment of a sensor element 10 according to the present invention has an inner solid-electrolyte layer 21d, to the surface of which an electrode or an electrode lead 40 is applied. The surface of the inner solid-electrolyte layer 21d and electrode/electrode lead 40 is covered by an outer solid-electrolyte layer 31d, which is applied using screen-printing technology.

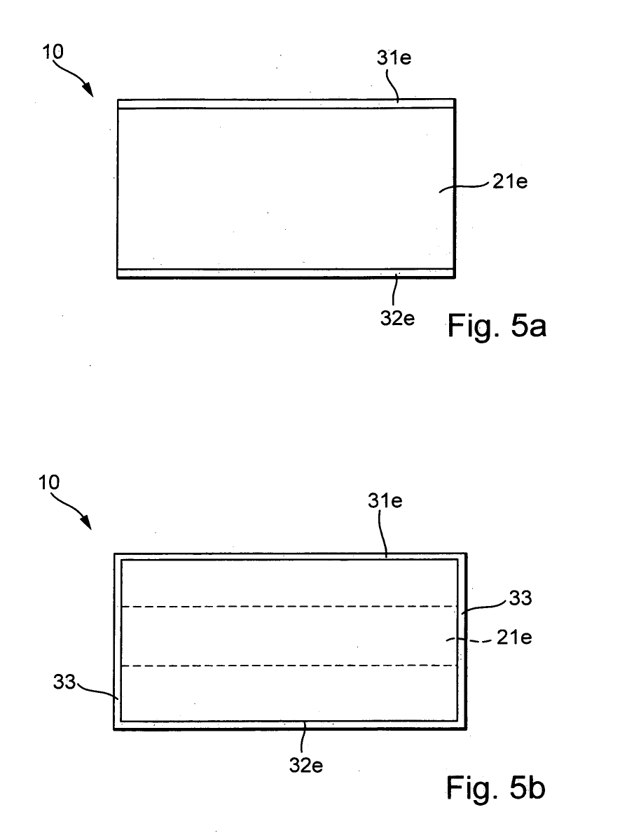

FIGS. 5a and 5b schematically show fifth and sixth exemplary embodiments of the sensor element according to the present invention. Sensor elements 10 shown in FIGS. 5a and 5b both include an inner solid-electrolyte layer 21e, the two main surfaces of which are completely covered by a first outer solid-electrolyte layer 31e and a second outer solid-electrolyte layer 32e. In sensor element 10 shown in FIG. 5b, the lateral surfaces of inner solid-electrolyte layer 21e are additionally covered by a further outer solid-electrolyte layer 33. To this end, the entire sensor element is coated on all sides (after being diced up), using a dipping operation, and subsequently dried and sintered, with the gas-entrance orifice, the region of terminal contacts, and the porous protective layer being removed.

In the exemplary embodiments of FIGS. 1 through 6, the outer solid-electrolyte layer has an yttrium-oxide content of 3 to 4 mole percent. However, the inner solid-electrolyte layer contains 4 to 7 mole percent yttrium oxide.

In the exemplary embodiment according to FIG. 1, the outer solid-electrolyte layers include first outer solid-electrolyte layer 31a and second outer solid-electrolyte layer 32a; in the exemplary embodiment according to FIG. 2, the outer solid-electrolyte layers include first outer solid-electrolyte layer 31b and second outer solid-electrolyte layer 32b; in the exemplary embodiment according to FIG. 3, the outer solid-electrolyte layers include first outer solid-electrolyte layer 31c and second outer solid-electrolyte layer 32c; in the exemplary embodiment according to FIG. 4, an outer solid-electrolyte layer 31d is included; in the exemplary embodiment according to FIG. 5a, the outer solid-electrolyte layers include first outer solid-electrolyte layer 31e and second outer solid-electrolyte layer 32e; and in the exemplary embodiment according to FIG. 5b, the outer solid-electrolyte layers include, in addition to first and the second outer solid-electrolyte layers 31e and 32, a further outer solid-electrolyte layer 33. In the exemplary embodiment according to FIG. 1, an inner solid-electrolyte layer 21a is provided; in the exemplary embodiment according to FIG. 2, the inner solid-electrolyte layers include first inner solid-electrolyte layer 21b and second inner solid-electrolyte layer 22b; in the exemplary embodiment according to FIG. 3, the inner solid-electrolyte layers include first inner solid-electrolyte layer 21c and second inner solid-electrolyte layer 22c; in the exemplary embodiment according to FIG. 4, an inner solid-electrolyte layer 21d is provided; and, in the exemplary embodiments according to FIGS. 5a and 5b, an inner solid-electrolyte layer 21e is provided.

In accordance with the present invention, an outer layer is also a solid-electrolyte layer, which is covered by a further layer, if this layer is not predominantly made out of a solid-electrolyte material, or if this layer only covers a small region of the outer surface of the outer solid-electrolyte layer. Thus, in the exemplary embodiment according to FIG. 1, first electrode 41, which is covered, on its part, by porous protective layer 52, is applied to first outer solid-electrolyte layer 31a. Porous protective layer 52 only covers a small region of the first outer solid-electrolyte layer 31a.

Described below are two examples of sensor elements which simultaneously achieve a reduction in the tendency to crack and improvement in the measuring performance, which sensor elements have the compositions of the inner and outer solid-electrolyte layers as specified below:

### EXAMPLE 1

The outer solid-electrolyte layer contains 3.5 mole percent yttrium oxide, and the inner solid-electrolyte layer contains 5.5 mole percent yttrium oxide.

### EXAMPLE 2

The outer solid-electrolyte layer contains 3 mole percent yttrium oxide, and the inner solid-electrolyte layer contains 6 mole percent yttrium oxide.

If the sensor element is made up of a plurality of solid-electrolyte layers, then the yttrium-oxide content of the solid-electrolyte layers may be graded, so that the transition between adjacent solid-electrolyte layers is softened, i.e., the difference in the yttrium-oxide level of adjacent solid-electrolyte layers is reduced.

In the exemplary embodiment according to FIG. 2, further solid-electrolyte layer 35 is situated between first inner solid-electrolyte layer 21b and first outer solid-electrolyte layer 31b. In order to soften the transition, further solid-electrolyte layer 35 has an yttrium-oxide content which is between the yttrium-oxide content of first inner solid-electrolyte layer 21b and the yttrium-oxide content of first outer solid-electrolyte layer 31b. Accordingly, first outer solid-electrolyte layer 31b in the second exemplary embodiment shown in FIG. 2 contains 3 mole percent yttrium oxide, further solid-electrolyte layer 35 contains 5 mole percent yttrium oxide, and first inner solid-electrolyte layer 21b contains 7 mole percent yttrium oxide.

1. A planar, layered sensor element for detecting a physical property of a gas to be analyzed, comprising:
two outer solid-electrolyte layers; and
at least one inner solid-electrolyte layer situated between the two outer solid-electrolyte layers;
wherein the inner solid-electrolyte layer is a first solid-electrolyte layer and one of the two outer solid-electrolyte layers is a second solid-electrolyte layer, and wherein the first solid-electrolyte layer and the second solid-electrolyte layer include zirconium oxide stabilized with yttrium oxide, and wherein the first solid-electrolyte layer has a higher yttrium-oxide content than the second solid-electrolyte layer, the yttrium-oxide content being based on the zirconium oxide.

2. The sensor element as recited in claim 1, wherein the first solid-electrolyte layer and the second solid-electrolyte layer have a level of zirconium oxide of at least 85 mole percent.

3. The sensor element as recited in claim 1, wherein the first solid-electrolyte layer has an yttrium-oxide content which is at least one mole percent greater than the yttrium-oxide content of the second solid-electrolyte layer, the yttrium-oxide content being based on the zirconium oxide.

4. The sensor element as recited in claim 1, wherein the first solid-electrolyte layer has an yttrium-oxide content of 4 to 7 mole percent, based on the zirconium oxide, and the second solid-electrolyte layer has an yttrium-oxide content of 3 to 4 mole percent, based on the zirconium oxide.

5. The sensor element as recited in claim 1, wherein the second solid-electrolyte layer is a solid-electrolyte foil having a layer thickness of at least 200 μm.

6. The sensor element as recited in claim 2, wherein the second solid-electrolyte layer is a solid-electrolyte foil having a layer thickness of at least 200 μm.

7. The sensor element as recited in claim 4, wherein the second solid-electrolyte layer is a solid-electrolyte foil having a layer thickness of at least 200 μm.

8. The sensor element as recited in claim 1, wherein the second solid-electrolyte layer covers at least one of an electrode and an electrode lead applied to a surface of the sensor element.

9. The sensor element as recited in claim 1, wherein the second solid-electrolyte layer substantially completely covers a surface of the sensor element.

10. The sensor element as recited in claim 1, further comprising:
a further solid-electrolyte layer provided on a surface of the at least one inner solid-electrolyte layer extending perpendicular to the top surface, the further solid-electrolyte layer and the second solid-electrolyte layer containing substantially the same composition levels of yttrium oxide and zirconium oxide.

11. The sensor element as recited in claim 1, further comprising:
a heater for heating a measuring region of the sensor element, and the second solid-electrolyte layer is provided on the side of the sensor element adjacent to the heater.

12. The sensor element as recited in claim 1, wherein the two outer solid-electrolyte layers have the same composition of the second solid-electrolyte layer, at least with respect to the levels of yttrium oxide and zirconium oxide.

13. The sensor element as recited in claim 2, wherein the first solid-electrolyte layer has an yttrium-oxide content which is at least one mole percent greater than the yttrium-oxide content of the second solid-electrolyte layer, the yttrium-oxide content being based on the zirconium oxide.

14. The sensor element as recited in claim 13, wherein the first solid-electrolyte layer has an yttrium-oxide content of 4 to 7 mole percent, based on the zirconium oxide, and the second solid-electrolyte layer has an yttrium-oxide content of 3 to 4 mole percent, based on the zirconium oxide.

15. The sensor element as recited in claim 14, wherein the second solid-electrolyte layer is a solid-electrolyte foil having a layer thickness of at least 200 μm.
